(19) United States
(12) Patent Application Publication
(10) Pub. No.: US 2014/0158854 A1
(43) Pub. Date: Jun. 12, 2014

(54) SKID FOR TRANSPORTING AND STORING A PORTABLE ANTENNA

(71) Applicant: WINEGARD COMPANY, Burlington, IA (US)

(72) Inventor: Timothy John Conrad, Mt. Pleasant, IA (US)

(73) Assignee: WINEGARD COMPANY, Burlington, IA (US)

(21) Appl. No.: 13/712,775

(22) Filed: Dec. 12, 2012

(51) Int. Cl. H01Q 1/12

(52) U.S. Cl. CPC H01Q 1/12
USPC 248/544

(57) ABSTRACT

A skid for transporting, deploying and storing a portable antenna has an antenna mounting frame providing a base for the antenna. A skid frame with an enclosure contains the antenna mounting frame and houses the antenna in the stowed position The enclosure also has a top opening to allow the antenna to be deployed. A lid covers the opening when the antenna is in the stowed position, and can be removed from the opening to allow the antenna to be deployed. The skid frame supports the antenna mounting frame and antenna, and also enables the entire skid assembly to lifted and transported. Shock isolation members between the skid frame and antenna mounting frame isolate the antenna from external shocks. The skid can also be equipped with a cable reel for holding cables for external connections to the antenna that is mounted inside a hinged gate attached to the skid frame.

### BACKGROUND OF THE INVENTION

1. Field of the Invention

The present invention relates generally to the field of portable antennas. More specifically, the present invention discloses a skid for deploying, transporting and storing a large portable satellite antenna.

2. Statement of the Problem

Portable satellite antennas have been used for many years in a variety of fields. Larger portable satellite antennas are widely used in remote locations during oil and gas exploration and drilling activities. Larger portable satellite antennas are also sometimes used in emergency response situations and military operations in the field.

These large satellite antennas present a variety of unique problems. Due to their large size and weight, they are typically hauled by truck or trailer, and must be loaded and unloaded by forklift. Satellite antennas are relatively delicate, and must be protected from dirt and debris, as well as the chains or tie-down straps used to secure the antenna to the truck or trailer. Satellite antennas must also be protected from vibration and mechanical shock experienced during loading, shipping, unloading and deployment. In addition, satellite antennas should be protected from damage by weather and adverse environmental conditions during storage and shipping.

After the antenna has arrived at its intended deployment location, the antenna should be relatively easy to unload and deploy. Ideally, the antenna should be straightforward to unload from a truck or trailer in the field using a conventional forklift. After unloading, the antenna should be simple to deploy and hook up, without the requiring the services of a skilled service technician. In addition, it is beneficial if the skid can provide a base for operation of the antenna during its deployment, and then continue in use for subsequent transportation of the antenna. Therefore, a need exists for a skid for large portable antennas that meets these shortcomings of the prior art in this field.

### SOLUTION TO THE PROBLEM

The present invention provides a skid for storing and transporting a large, portable satellite antenna that addresses these issues. The present invention includes shock isolation members for protecting the antenna against shock and vibration during transportation. The enclosure of the present invention help to protect the antenna against dirt, debris, environmental conditions and chains used to secure the antenna during transportation. The bi-fold lid can be easily opened and folded against the exterior of the skid to allow deployment of the antenna. Additionally, the present invention is equipped with a cable reel mounted on a hinged gate that can be pivoted out from the enclosure when the antenna is deployed to provide quick and easy cable connections to the antenna.

### SUMMARY OF THE INVENTION

This invention provides a skid for transporting and storing a portable antenna having an antenna mounting frame providing a base for the antenna. A skid frame with an enclosure contains the antenna mounting frame and houses the antenna in the stowed position The enclosure has a top opening to allow the antenna to be deployed. A lid covers the opening when the antenna is in the stowed position, and can be removed to allow the antenna to be deployed. The skid frame supports the antenna mounting frame and antenna, and also enables the skid to be lifted and transported. Shock isolation members between the skid frame and antenna mounting frame isolate the antenna from external shocks. The skid can also be equipped with a cable reel for holding cables for external connections to the antenna that is mounted inside a hinged gate attached to the skid frame.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a perspective view of the skid with the antenna 10 in its deployed position and a portion of an enclosure wall 30 cut away to show the shock isolation members 24 within the skid.

FIG. 2 is a perspective view of the skid with the antenna 10 stowed and one of the bi-fold lids 39 open and the other bi-fold lid 38 partially closed.

FIG. 3 is a top view corresponding to FIG. 2.

FIG. 4 is a bottom view corresponding to FIGS. 2 and 3.

FIG. 5 is a rear view corresponding to FIGS. 2-4.

FIG. 6 is a front view corresponding to FIGS. 2-5.

FIG. 7 is a right side view corresponding to FIGS. 2-6 with portions of the wall panel 30 cut away to show the shock isolation members 24 within the skid.

FIG. 8 is a left side view corresponding to FIGS. 2-7 with portions of the wall panel 30 cut away to show the shock isolation members 24 within the skid.

FIG. 9 is a detail side view of one of the shock isolation members 24 between the skid frame 20 and antenna mounting frame 12 near the right end of the skid.

FIG. 10 is a detail side view of one of the shock isolation members 24 between the skid frame 20 and antenna mounting frame 12 near the left end of the skid.

### DETAILED DESCRIPTION OF THE INVENTION

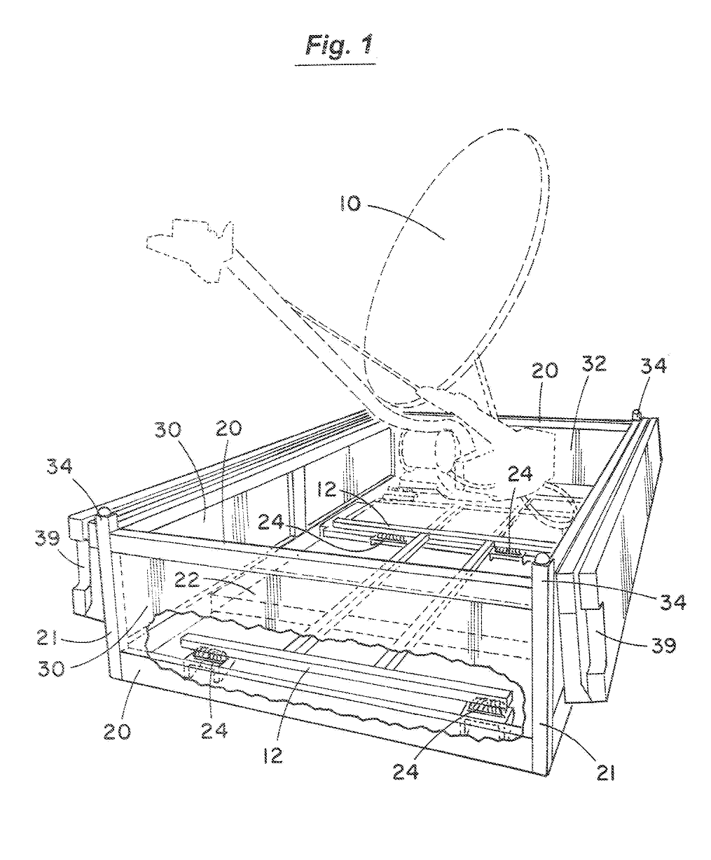

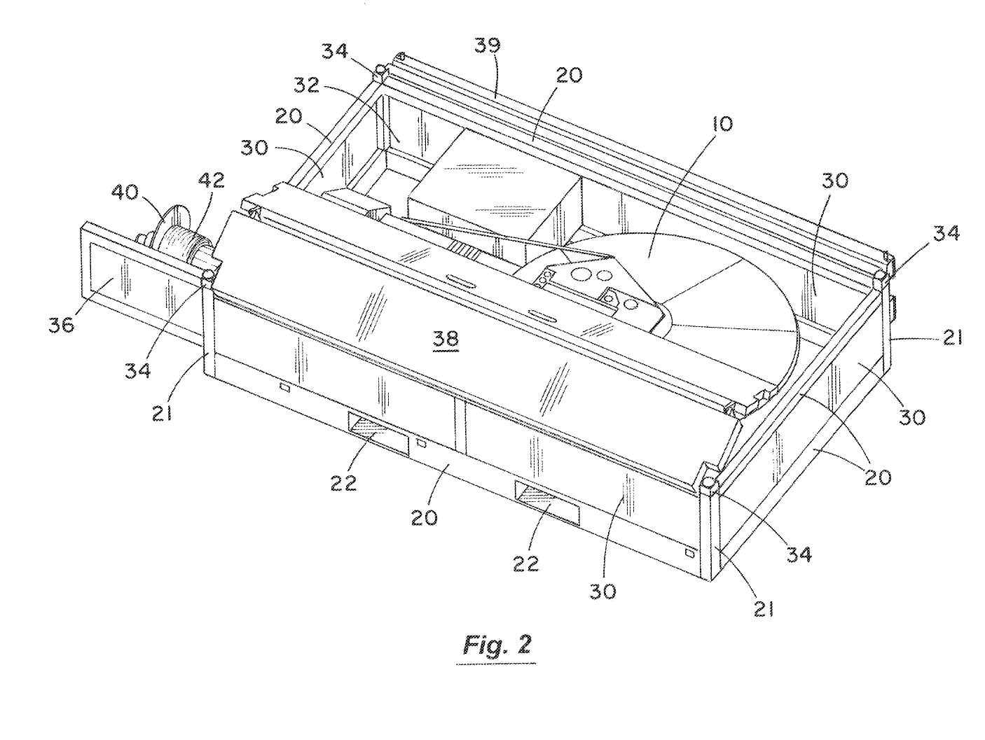

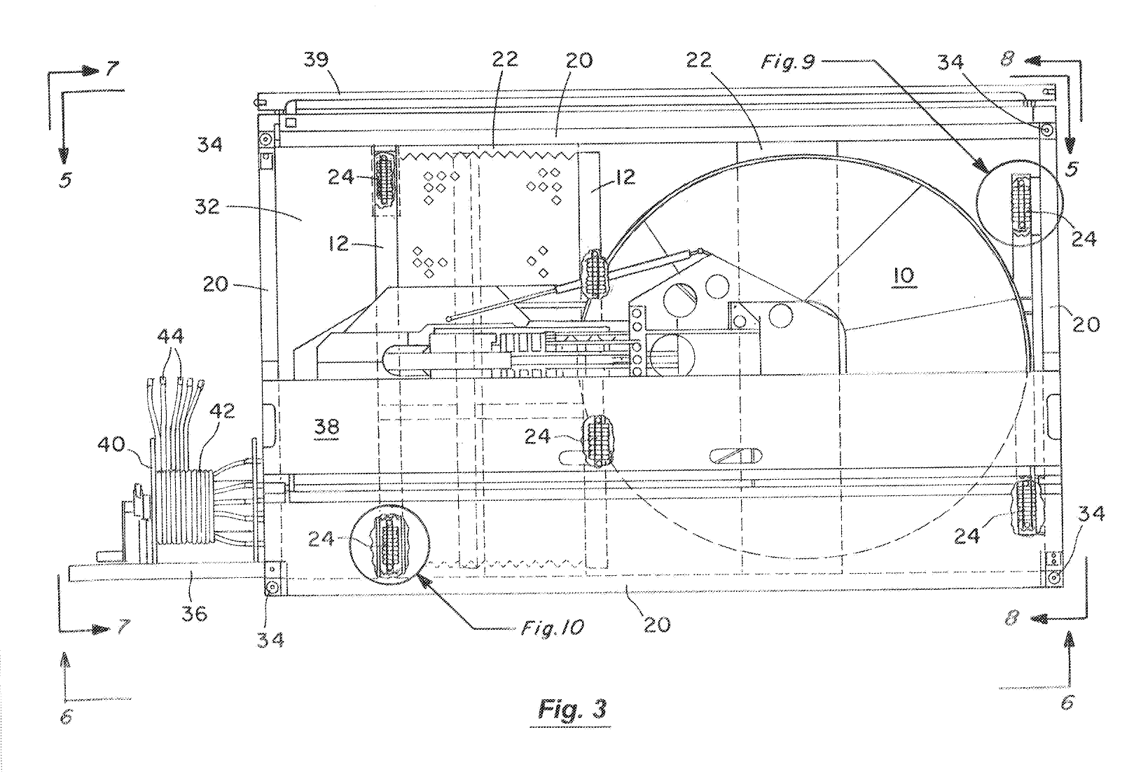

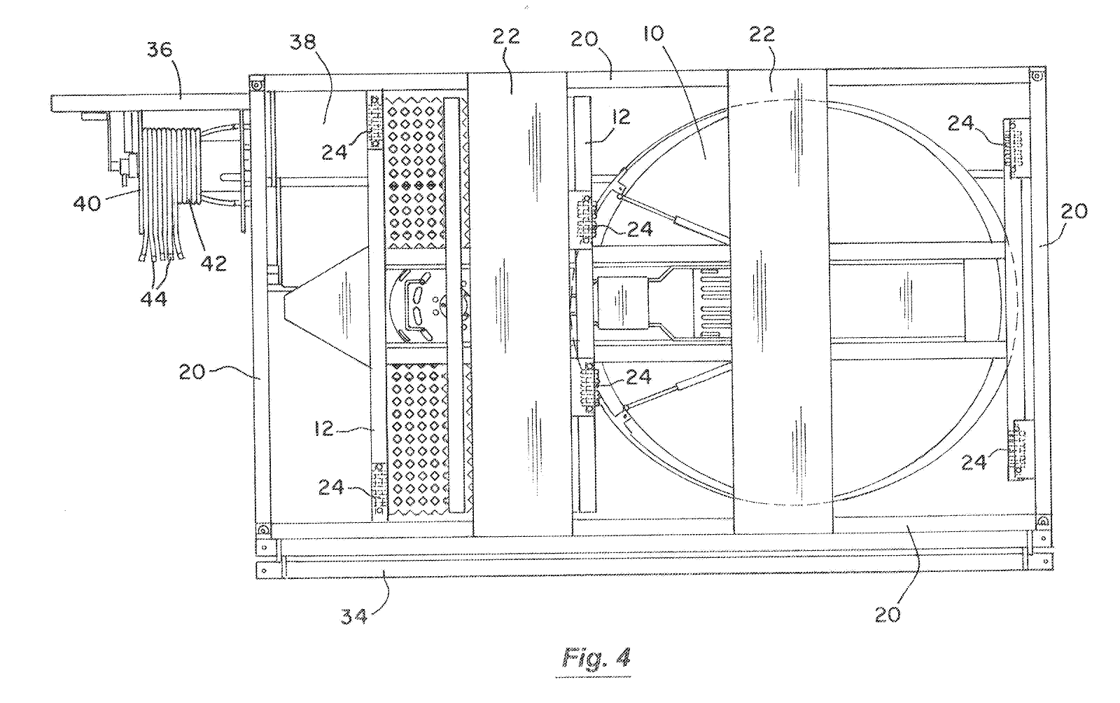

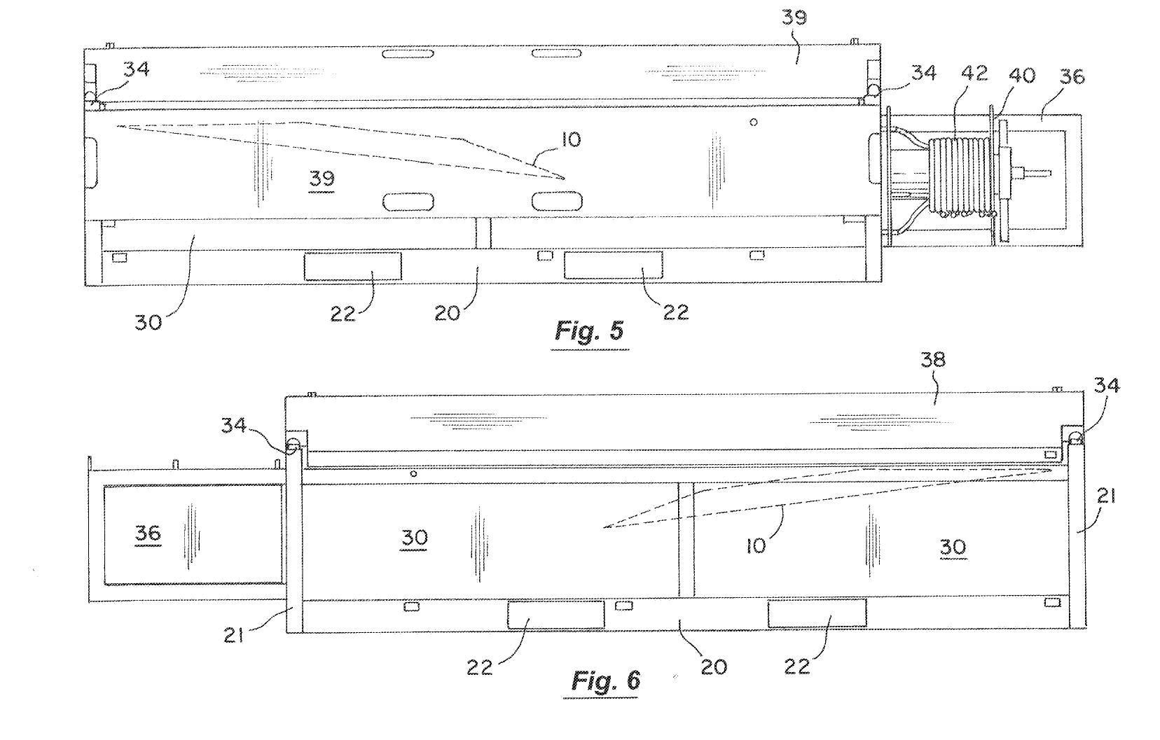

Turning to FIG. 1, a perspective view is providing showing an embodiment of the present skid. As a general overview, the major components of the skid include a box-like skid frame 20, 21 and 30, and an antenna mounting frame 12 housed within the enclosure defined by the skid frame. This antenna mounting frame 12 serves as the base for an antenna 10 that can move between a deployed position, shown in FIG. 1, and a stowed position within the enclosure of the skid frame, shown in FIG. 2. FIGS. 3-6 are top, bottom, rear and front views, respectively, corresponding to FIG. 2.

In the embodiment shown in the accompanying figures, the skid frame includes a rectilinear frame of horizontal and vertical members 20, 21 creating a box-like structure with an enclosed interior space for storing and protecting the antenna 10 in its stowed position. A series of panels or walls 30 (e.g., thin metal panels) attached to the horizontal and vertical members 20, 21 enclose the skid frame to help protect the antenna 10 from dirt, debris and damage during storage and transportation. The skid frame can have the general shape of a rectangular box in its stowed state to facilitate stacking multiple units for storage and transportation. However, it should be understood that other geometric shapes could be readily substituted.

The skid frame also includes a top opening 32. Two lids 38, 39 cover the top opening 32 when the antenna 10 is stowed to help protect the antenna 10 from dirt, debris and damage. The lids 38, 39 can be opened or removed to allow access to the antenna 10, and to enable the antenna 10 to be deployed through the top opening as shown in FIG. 1. Preferably, the lids 38, 39 should not be detachable from the skid to reduce the risk of their loss or damage.

In the embodiment shown in the accompanying drawings, the lids consist of two sets of bi-fold doors 38 and 39 that are hinged to the top lateral edges of the skid frame, and can be manually opened and closed over the top opening 32. The bi-fold doors 38, 39 can be folded against the exterior sides of the skid when opened, as illustrated in FIG. 1. This lid-retaining feature prevents the open lids from swinging open away from the skid. In FIGS. 2-8, one set of bi-fold doors 39 are shown folded against the exterior side of the skid, while the other set of bi-fold doors 38 are shown in a partially open state.

The structural members of the lower portion of the skid frame beneath the enclosure serve as a base for lifting the entire skid assembly. Optionally, the skid frame can include a number of forklift pockets 22 in the lower sides of the skid, as shown in FIG. 2, to facilitate use a conventional forklift in lifting and transporting the skid. These forklift pockets 22 remain accessible when the bi-fold doors 38, 39 are open and folded against the sides of the skid.

The antenna mounting frame 12 is contained within the enclosure of the skid frame, and supported above the base of the skid frame. In turn, the antenna mounting frame 12 provides a base for supporting the antenna 10 within the enclosure of the skid frame.

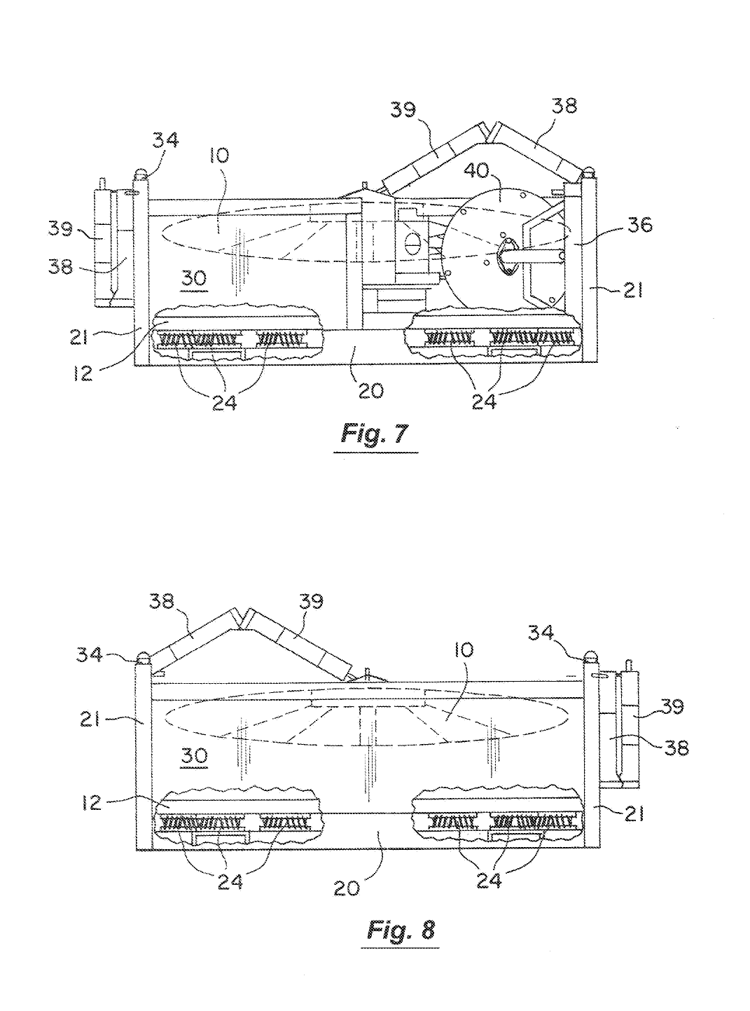

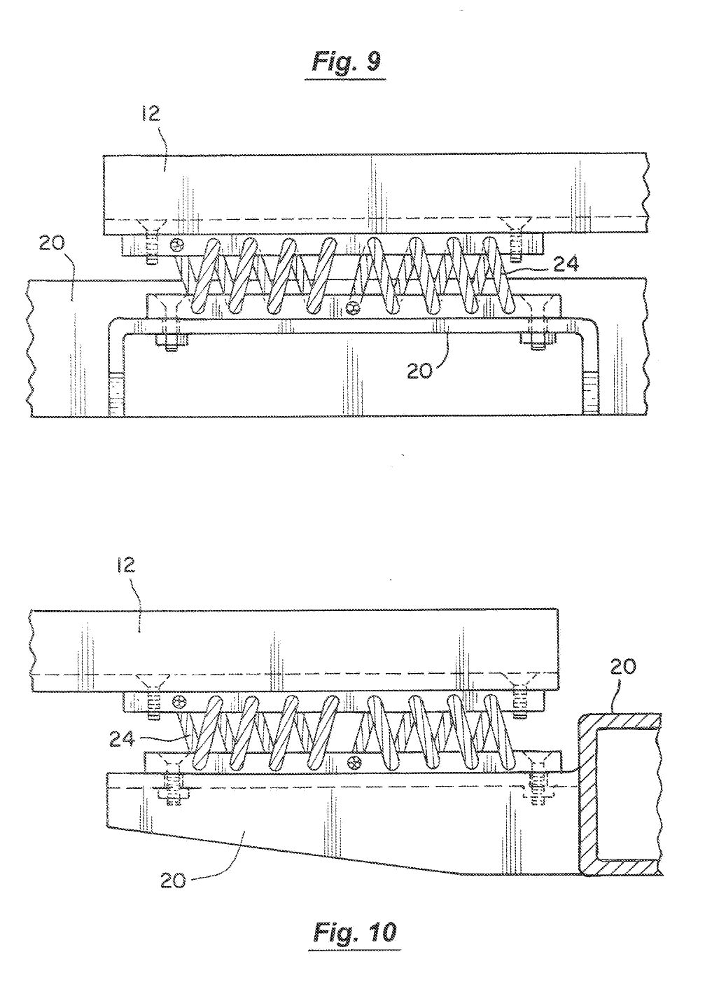

A set of shock isolation members 24 isolate the delicate antenna 10 from vibration and mechanical shock during transportation and loading. For example, the shock isolation members 24 can be made of a coil of flexible material (e.g., coiled metal cable) running through sets of openings in the skid frame and antenna mounting frame 12. FIGS. 7 and 8 are right and left side views, respectively, corresponding to FIG. 2 with portions of the wall panel 30 cut away to show the shock isolation members 24 within the skid. FIGS. 9 and 10 are detail side views of the shock isolation members 24 between the skid frame and antenna mounting frame 12 near the right and left ends, respectively, of the skid.

The enclosure within the skid has sufficient space to accommodate two weatherproof cases (not shown) containing the satellite antenna control unit, modem and other electronics equipment. These cases are isolated from the vibration and mechanical shock of the truck or trailer by the shock isolation members 24, and can be secured in place with tie-down straps that crisscross each case to prevent them from coming loose during shipment.

Optionally, the skid frame can be equipped with a set of short stacking legs 34 extending upward from each of the upper corners of the skid. These stacking legs 34 are designed to enable a number of skids to be stacked atop one another when closed to minimize storage space requirements. Each stacking leg 34 seats in a corresponding recess in the bottom of the skid above to maintain vertical alignment of the stacked skids.

The skid is also provided with a cable reel 40 for storing cables 42 with connectors 44 for external connections to the antenna 10, as shown in its open position in FIGS. 2-6. The cable reel 40 is mounted to a hinged gate 36 attached to the skid frame. When the antenna is deployed, the hinged gate 36 and cable reel 40 can be locked in the open position to allow the cables 42 to be unreeled and connected to the control unit and modem for the antenna 10 via the cable connectors 44. This hinged configuration eliminates any need to lift a heavy cable reel. When the hinged gate 36 and cable reel 40 are in the open position, there is sufficient clearance within the skid enclosure for the antenna 10 to rotate. For example, many oil and gas exploration companies have a need to use satellite antennas at remote drilling sites, but wish to avoid the expense of sending a skilled service technician to these sites. The present skid can be used in combination with an auto-acquire satellite antenna that greatly simplifies the required set-up procedure and eliminates the need for a skilled service technician on-site. The antenna can be set up by simply opening the lids of the skid, connecting a few coax cables to the controller and modem, then pressing the “find satellite” button.

When the antenna 10 is not in use, the cable reel 40 can be pivoted into the interior enclosure of the skid for storage, and the hinged gate 36 can be secured in the closed position by a latch. In the closed position, the hinged gate 36 is flush with the exterior surface of the skid for storage and transportation of the skid, and the cable reel 40 and cables 42 are protected within skid frame.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A skid for transporting and storing a portable antenna having a stowed position and a deployed position, said skid comprising:
an antenna mounting frame providing a base for an antenna;
a skid frame supporting the antenna mounting frame and enabling the skid to lifted and transported, said skid frame defining an enclosure containing the antenna mounting frame and housing the antenna in the stowed position, said enclosure having a top opening to allow the antenna to be deployed through the top opening;
a lid covering the top opening when the antenna is in the stowed position, said lid being removable from the top opening to allow the antenna to be deployed through the opening; and
shock isolation members between the skid frame and antenna mounting frame to isolate the antenna from external shocks.

2. The skid of claim 1 wherein the lid comprises bi-fold doors.

3. The skid of claim 2 wherein the bi-fold doors can be folded against an exterior side of the skid when opened.

4. The skid of claim 1 wherein the skid frame defines a rectangular box.

5. The skid of claim 1 wherein at least one of the shock isolation members comprises a coil of flexible material running through sets of openings in the skid frame and antenna mounting frame.

6. The skid of claim 1 further comprising forklift pockets extending through the skid frame aligned to enable a forklift to lift the skid frame.

7. The skid of claim 1 further comprising a cable reel for holding cables providing external connections to the antenna.

8. The skid of claim 7 wherein the cable reel is mounted inside a hinged gate attached to the skid frame.

9. A skid for transporting and storing a portable antenna having a stowed position and a deployed position, said skid comprising:
an antenna mounting frame providing a base for an antenna;
a skid frame supporting the antenna mounting frame and enabling the skid to lifted and transported, said skid frame defining an enclosure containing the antenna mounting frame and housing the antenna in the stowed position, said enclosure having a top opening to allow the antenna to be deployed through the top opening;
shock isolation members between the skid frame and antenna mounting frame to isolate the antenna from external shocks;
a lid covering the top opening when the antenna is in the stowed position, said lid being removable from the top opening to allow the antenna to be deployed through the top opening;
a gate hinged to the skid frame; and
a cable reel for holding cables providing external connections to the antenna, said cable reel being mounted on the gate to be stored within the enclosure of the skid frame when the gate is in the closed position.

10. The skid of claim 9 wherein the lid comprises bi-fold doors.

11. The skid of claim 9 wherein at least one of the shock isolation members comprises a coil of flexible material running through sets of openings in the skid frame and antenna mounting frame.

12. The skid of claim 9 further comprising forklift pockets extending through the skid frame beneath the enclosure to enable a forklift to lift the skid frame.

13. A skid for transporting and storing a portable antenna having a stowed position and a deployed position, said skid comprising:
a skid frame having a base and defining an enclosure above the base with an top opening, said enclosure housing an antenna in the stowed position and allowing the antenna to be deployed through the top opening;
an antenna mounting frame contained within the enclosure and supported above the base of the skid frame, said antenna mounting frame providing a base for supporting the antenna;
shock isolation members between the skid frame and antenna mounting frame to isolate the antenna from external shocks;
forklift pockets extending through the base of the skid frame beneath the enclosure and antenna mounting frame to enable a forklift to lift the skid; and
a lid covering the top opening when the antenna is in the stowed position, said lid being removable from the top opening to allow the antenna to be deployed through the top opening.

14. The skid of claim 13 further comprising:
a gate hinged to the skid frame; and
a cable reel for holding cables providing external connections to the antenna, said cable reel being mounted on the gate to be stored within the enclosure of the skid frame when the gate is in the closed position.

15. The skid of claim 13 wherein at least one of the shock isolation members comprises a coil of flexible material running through sets of openings in the skid frame and antenna mounting frame.

16. The skid of claim 13 wherein the lid comprises bi-fold doors.
